(19) United States
(12) Patent Application Publication
(10) Pub. No.: US 2014/0119071 A1
(43) Pub. Date: May 1, 2014

(54) Overload Protection Saving Circuit

(71) Applicant: Asian Power Devices Inc., Taoyuan City (TW)

(72) Inventor: Liang-Shu Xu, Taoyuan City (TW)

(21) Appl. No.: 13/926,986

(22) Filed: Jun. 25, 2013

(30) Foreign Application Priority Data
Oct. 31, 2012 (TW) 101221136

(51) Int. Cl. H02M 1/32

(52) U.S. Cl. CPC H02M 1/32
USPC 363/50

(57) ABSTRACT

An overload protection saving circuit provided by the present invention has an input power circuit, an output power circuit, a control circuit, an overload timing circuit, and a saving circuit. The output power circuit couples to the input power circuit. The control circuit receives a feedback signal of the output power circuit in order to control the input power circuit. The overload timing circuit receives the feedback signal of the output power circuit in order to transmit an overload signal to the control circuit while the time of an overload is over a predetermining time. The saving circuit receives the feedback signal of the output power circuit in order to transmit a saving signal to the overload timing circuit while in a lightload or a noload, so that the overload timing circuit is disabled.

### BACKGROUND OF THE INVENTION

1. Field of the Invention

The present invention generally relates to an overload protection saving circuit, more particularly to an overload protection saving circuit that is applied to a switching power supplier.

2. Description of the Prior Art

Switching power suppliers can be used to convert AC power to DC power, and to output DC power to the load of an electronic device. If an overload happens while in outputting power, a protection circuit is a must to temporarily cut the output for avoiding danger.

FIG. 1A illustrates a schematic view of a switching power circuit in prior arts. Fig. B illustrates a schematic view of an overload timing circuit of the switching power circuit of FIG. 1A. With reference to FIG. 1A and FIG. 1B, the prior switching power circuit 100 has an input power circuit 110, an output power circuit 120, a control circuit 130, and an overload timing circuit 140.

The input power circuit 110 couples the output power circuit 120 in order to transmit a primary side of an external power energy to a secondary side via a transformer, and then to a load.

The control circuit 130 is to detect the variety of the load, and then dynamically switches a switch of a transistor Q1 of the input power circuit 110, so as to adjust the power energy of from the primary side to the secondary side. While a system happens an overload, the control circuit 130 temporarily turns off the transformer Q1 for safety.

Normally, the control circuit 130 is consisted of a pulse width modulation (PWM) chip, and detects the variety of a load through a photo coupler so as to receive a feedback signal fs of the power circuit 120 at a feedback end FB.

The overload timing circuit 140 may also couple to the feedback end FB of the control circuit 130 in order to receive the feedback signal fs. While an overload happens, the overload timing circuit 140 starts counting time, and transmits an overload signal os to the control circuit via the feedback end FB in order to let the control circuit 130 turn off the transformer Q1 while the time of the overload is over a predetermining time.

Besides, the control circuit 130 and the overload timing circuit 140 both can couple to an auxiliary side of the input power circuit 110 for acquiring the power of the auxiliary side of a power end Vcc.

In detail, the overload timing circuit 140 has a timing circuit 142, a latch circuit 144 and a regulator circuit 146. The timing circuit 142 couples the feedback end FB to receive the feedback signal fs. While an overload happens, the voltage of the feedback signal fs may abnormally raise up, a comparator OPA1 outputs a high level potential to charge a capacitor C1.

The capacity of the capacitor C1 is a factor to decide how long the capacitor C1 will be charged, and is another factor to decide the value of the predetermining time. While the voltage of the capacitor C1 raises up to a certain level, a comparator OPA2 may output a high level potential in order to activate the latch circuit 144 for transmitting an overload signal os.

Specifically, while the comparator OPA2 outputs a high level potential, a transformer Q2 is activated to conduct an LED D1 (a transformer Q3 is activated simultaneously), so as to let the potential of the feedback end FB be near the low level potential of a ground. Such that, the control circuit 230 may turn off the transistor Q1 for safety.

Continuously, the capacitor C2 of the latch circuit 144 keeps on discharging electricity. While the voltage of the capacitor C2 lowers down to a certain level, the transistor Q3 may turn off (transistor Q2 turns off simultaneously) the LED D1 in order to release the latch circuit 244. As aforesaid, the time to release can decide the capacity of the capacitor C2.

The regulator circuit 146 couples to the power end Vcc, and transforms the power of the power end Vcc to a reference voltage Vref for activating the timing circuit 142. The comparators OPA1 and OPA2 may need the reference voltage Vref in order to determine whether an overload happens or not.

Generally speaking, while the switching power circuit 100 is in heavy load, the overload timing circuit 140 must keep on monitoring the condition of the heavy load for safety. However, while the switching power circuit 100 is in noload or lightload, the regulator circuit 146 may provide power to the timing circuit 142 in order to let the comparators OPA1 and OPA2 continuously consume the power for determining whether an overload happens or not, and it causes the usage rate of power lowers down.

### SUMMARY OF THE INVENTION

The main objective of the present invention is to provide an overload protection saving circuit, which tremendously promote the usage rate of the power source of a system while in a lightload or noload.

To approach above objective, the overload protection saving circuit provided by the present invention has an input power circuit, an output power circuit, a control circuit, an overload timing circuit, and a saving circuit. The output power circuit couples to the input power circuit. The control circuit receives a feedback signal of the output power circuit in order to control the input power circuit. The overload timing circuit receives the feedback signal of the output power circuit in order to transmit an overload signal to the control circuit while the time of an overload is over a predetermining time. The saving circuit receives the feedback signal of the output power circuit in order to transmit a saving signal to the overload timing circuit while in a lightload or a noload, so that the overload timing circuit is disabled.

For an embodiment, the overload timing circuit has a timing circuit, a latch circuit and a regulator circuit. The timing circuit uses a feedback end of the control circuit to receive the feedback signal of the output power circuit, and starts to count time while the overload happens. The timing circuit outputs a high level potential to the latch circuit while the time of the overload is over the predetermining time, so that the latch circuit keeps the level of the feedback end at a lower level potential. The regulator circuit provides a reference voltage to the timing circuit. The saving circuit receives the feedback signal of the output power circuit at the feedback end of the control circuit. The regulator circuit may not provide the reference voltage to the timing circuit while in the lightload or noload.

As a conclusion, in the overload protection saving circuit, the saving circuit detects the conditions of load, the overload timing circuit is turned off while in the lightload or noload in order to decrease the loss of energy and highly raise up the usage rate of power source.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a schematic view of a switching power circuit in prior arts;

Fig. B illustrates a schematic view of an overload timing circuit of the switching power circuit of FIG. 1A;

FIG. 2A illustrates a schematic view of an embodiment of the overload protection saving circuit of the present invention; and

FIG. 2B illustrates a schematic view of an overload timing circuit and a saving circuit of the overload protection saving circuit of Fig. A.

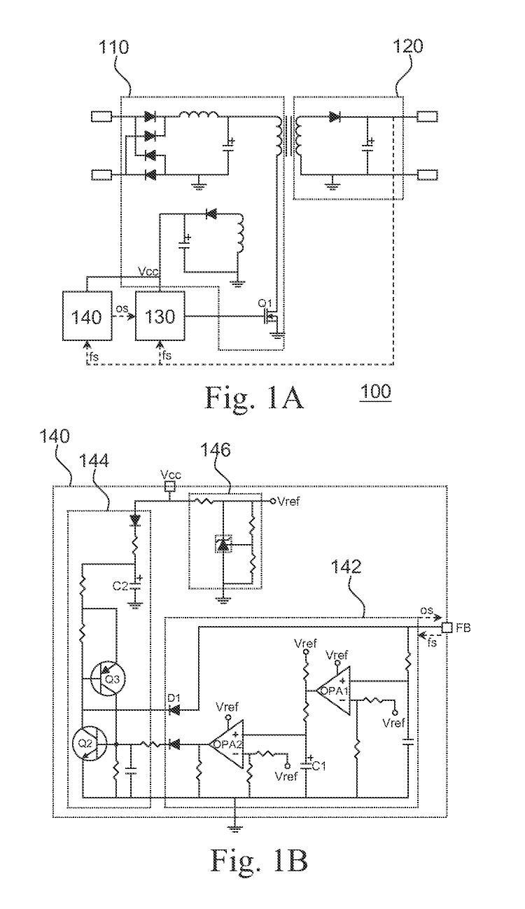

### DETAILED DESCRIPTION OF THE INVENTION

Following preferred embodiments and figures will be described in detail so as to achieve aforesaid objects.

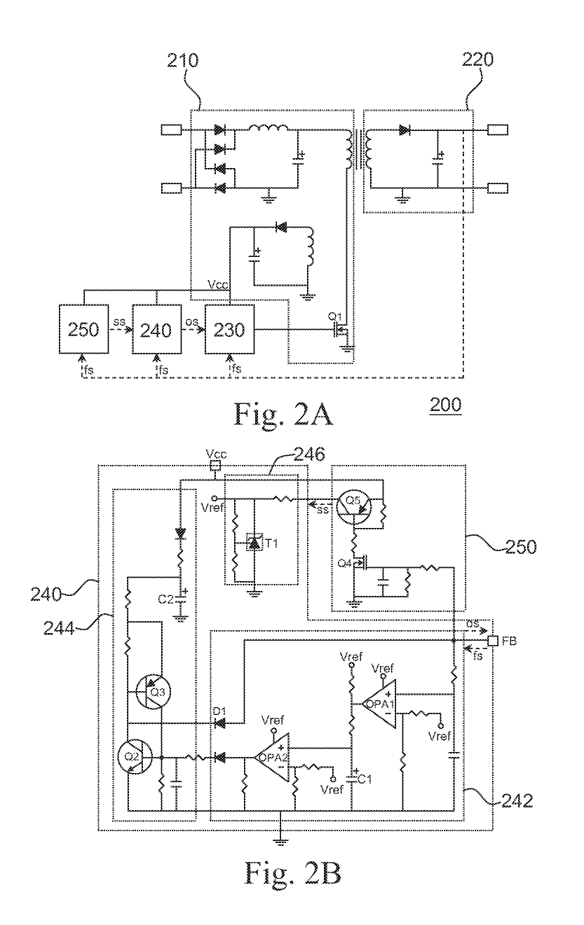

With reference to FIG. 2A and FIG. 2B, which illustrate a schematic view of an embodiment of the overload protection saving circuit of the present invention and a schematic view of an overload timing circuit and a saving circuit of the overload protection saving circuit of the present invention. As shown in FIG. 2A and FIG. 2B, an overload protection saving circuit has an input power circuit 210, an output power circuit 220, a control circuit 230, an overload timing circuit 240, and a saving circuit 250.

The input power circuit 210 couples to the output power circuit 220 in order to transmit a primary side of an AC power energy to a secondary side via a transformer, and then to a load. For the embodiment, the output power circuit 220 is a Flyback structure, a Forward structure, a Push-Pull structure, or other suitable structure.

The control circuit 230 is to detect the variety of the load, and then dynamically switches a switch of a transistor Q1 of the input power circuit 210, so as to adjust the power energy of from the primary side to the secondary side. For the embodiment, the control circuit 230 adopts a pulse width modulation chip, model number LD7536, of Leadtrend, and detects the variety of the load via a photo coupler. The control circuit 230 receives a feedback signal (fs) of the output power circuit (220) in order to separate the primary side and the secondary side.

Specifically, the variety of the load may cause the variety of voltage of the feedback signal fs. The control circuit 230 dynamically modulates a switch period of the transistor Q1 depending on the detected voltage of the feedback signal fs, so that a stable voltage can be assured to output. When an overload happens in a system, the control circuit 230 is able to temporarily turn off the transistor Q1 for safety.

The overload timing circuit 240 may also couple to a feedback end FB of the control circuit 230 in order to receive the feedback signal fs of the output power circuit 220. While the time of the overload is over a predetermining time, the overload timing circuit 240 transmits an overload signal to the control circuit 230 via the feedback end FB so as to let the control circuit 230 turn off the transistor Q1.

The saving circuit 250 may also couple to the feedback end FB of the control circuit 230 in order to receive the feedback signal fs of the output power circuit 220. The saving circuit 250 transmits a saving signal ss to the overload timing circuit (240) while the system is in a lightload or a noload, so that the overload timing circuit 240 is disabled.

Besides, the control circuit 230, the overload timing circuit 240 and the saving circuit 250 all can couple to an auxiliary side of the input power circuit 210 for acquiring the power of the auxiliary side of a power end Vcc.

For the embodiment, the overload timing circuit 240 has a timing circuit 242, the latch circuit 244 and a regulator circuit 246. The timing circuit 242 couples the feedback end FB to receive the feedback signal fs. While an overload happens, the voltage of the feedback signal fs may abnormally raise up, a comparator OPA1 outputs a high level potential to charge a capacitor C1.

The capacity of the capacitor C1 is a factor to decide how long the capacitor C1 will be charged, and is another factor to decide the value of the predetermining time. While the voltage of the capacitor C1 raises up to a certain level, a comparator OPA2 may output a high level potential in order to activate the latch circuit 244 for transmitting an overload signal os.

Specifically, while the comparator OPA2 outputs a high level potential, a transformer Q2 is activated to conduct an LED D1 (a transformer Q3 is activated simultaneously), so as to let the potential of the feedback end FB be near the low level potential of a ground. Such that, the control circuit 230 may turn off the transistor Q1 for safety.

Continuously, the capacitor C2 of the latch circuit 244 keeps on discharging electricity. While the voltage of the capacitor C2 lowers down to a certain level, the transistor Q3 may turn off (transistor Q2 turns off simultaneously) the LED D1 in order to release the latch circuit 244. As aforesaid, the time to release can decide the capacity of the capacitor C2.

In addition, the regulator circuit 246 couples to the power end Vcc, and transforms the power of the power end Vcc to a reference voltage Vref for activating the timing circuit 242. The embodiment can be equipped with a regulator T1 and a series resistors in order to output the stable reference voltage Vref, wherein the regulator T1, Model Number TL431, is a three-terminal adjustable regulator. While the timing circuit 242 receives the reference voltage Vref of the regulator circuit 246, the comparators OPA1 and OPA2 may work properly in order to continuously monitor whether an overload happens or not.

While the system is in the lightload or noload, the voltage of the feedback signal fs is lower than the normal voltage, therefore a transistor Q4 of the saving circuit 250 is not activated and a transistor Q5 may turn off as well. Such that, the power of the power end Vcc cannot drive the regulator T1 so as to let the regulator circuit 246 provide the reference voltage Vref.

If the timing circuit 242 cannot receive the reference voltage Vref of the regulator circuit 246, the components (more particularly to the comparators OPA1 and OPA2) of the timing circuit 242 will be disable, so that the loss of lowering energy may highly promote the usage rate of power while the system is in lightload or noload.

While the system is back to a normal load or a heavy load, the voltage of the feedback signal fs raises up in order to activate the transistor Q4 of the saving circuit 250, and then to the transistor Q5. Such that, the power of the power end Vcc can drive the regulator T1 so as to let the regulator circuit 246 provide the reference voltage Vref for the timing circuit 242 working properly.

It is to be noted that the loss of the energy of the saving circuit 250 is much lower than the loss of the energy of the overload timing circuit 240, the saving structure of the present invention can raise up the usage rate of power source.

Another notice is that the present invention adopts the saving circuit 250 to detect load conditions, and the overload timing circuit 240 is turned off to lower down the loss of power while the system is in a lightload or noload. The present invention may not limit the arrangement of the overload timing circuit 240 and the saving circuit 250 of FIG. 2B. Persons skilled in the art may slightly alter the spirits of the present invention and such alteration is still in the scope of the present invention.

Compared to prior arts, the present invention has following advantages listed below:
1. While a system is in a lightload or noload and using a saving circuit, the overload timing circuit is turned off to lower the loss, and the usage rate of the power source of the system is tremendously raised up.
2. The loss of the energy of the saving circuit is much lower than the loss of the energy of the overload timing circuit, the overall saving structure of the system can raise up the usage rate of power source.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An overload protection saving circuit comprising:
an input power circuit (210);
an output power circuit (220), coupling to the input power circuit (210);
a control circuit (230), receiving a feedback signal (fs) of the output power circuit (220) in order to control the input power circuit (210);
an overload timing circuit (240), receiving the feedback signal (fs) of the output power circuit (220) in order to transmit an overload signal (os) to the control circuit (230) while the time of an overload is over a predetermining time; and
a saving circuit (250), receiving the feedback signal (fs) of the output power circuit (220) in order to transmit a saving signal ss to the overload timing circuit (240) while in a lightload or a noload, so that the overload timing circuit (240) is disabled.

2. The overload protection saving circuit according to claim 1, wherein the overload timing circuit (240) comprises:
a timing circuit (242), using a feedback end (FB) of the control circuit to receive the feedback signal (fs) of the output power circuit (220), starting to count time while the overload happens;
a latch circuit (244), coupling to the timing circuit (242), the timing circuit (242) outputting a high level potential to the latch circuit (244) while the time of the overload is over the predetermining time, so that the latch circuit (244) keeps the level of the feedback end (FB) at a lower level potential; and
a regulator circuit (246), providing a reference voltage (Vref) to the timing circuit (242);
wherein the saving circuit (250) receives the feedback signal (fs) of the output power circuit (220) at the feedback end of the control circuit (230), the regulator circuit (246) not providing the reference voltage (Vref) to the timing circuit (242) while in the lightload or noload.
